(19) United States
(12) Patent Application Publication
(10) Pub. No.: US 2017/0197330 A1
(43) Pub. Date: Jul. 13, 2017

(54) Method of Making Objects Including One or More Carbides

(71) Applicant: Halliburton Energy Services, Inc., Houston, TX (US)

(72) Inventor: Jim Basuki Surjaatmadja, Duncan, OK (US)

(73) Assignee: Halliburton Energy Services, Inc., Houston, TX (US)

(21) Appl. No.: 15/324,396

(22) PCT Filed: Aug. 7, 2014
(86) PCT No.: PCT/US2014/050186

§ 371 Date: Jan. 6, 2017

(51) Int. Cl. B28B 1/00; B33Y 30/00; C04B 35/64; C22C 29/10; C04B 35/56; C04B 35/622; B33Y 10/00; C22C 29/08

(52) U.S. Cl. CPC B28B 1/001; B33Y 10/00; B33Y 30/00; C22C 29/08; C22C 29/10; C01B 31/34; C04B 35/5626; C04B 35/62218; C04B 35/64; C01P 2004/62; C01P 2004/61; C04B 2235/3847; C04B 2235/3418; C04B 2235/5436; C04B 2235/5445; C04B 2235/5454; C04B 2235/665

(57) ABSTRACT

Various embodiments relate to methods, apparatuses, and systems for manufacturing objects including at least one carbide. In various embodiments, the present invention provides a method of manufacturing an object. The method can include depositing a powder including at least one carbide. The method can include exposing at least part of the powder to a laser light to heat the exposed powder sufficiently to at least partially liquefy or at least partially plasticize the powder such that after the exposing the exposed powder cools to form a solidified powder. The method can also include repeating the depositing and the exposing for multiple cycles to form an object including the solidified powder from the multiple cycles.

### BACKGROUND

Various carbides have valuable properties for a variety of industrial applications. For example, tungsten carbide (WC) is an inorganic chemical compound containing equal parts of tungsten and carbon atoms. Tungsten carbide is about two times stiffer than steel, is much denser than steel or titanium, and has a hardness similar to corundum or sapphire/ruby. Tools and parts made of tungsten carbide are very abrasion resistant, can withstand high temperatures, and can maintain a sharp cutting edge better than parts and tools made from other materials. Most tungsten carbide tools and parts include lower melting point binders to help solidify the tungsten carbide.

Isostatic processes that compact a particulate preform at right angles to the exterior surface can be used to generate tungsten carbide objects, such as cold isostatic processing (CIP), hot isostatic processing (HIP), and rapid omnidirectional compaction (ROC). However, these processes are complex and time-consuming, and can result in objects having inconsistent density or low density. While isostatic processes can improve strength in tungsten carbide products, they can generate stresses in the object which in turn weaken the object to some extent. Such stresses are actually much greater in ROC processes, which use very high compaction stresses for creating a near absolute densified product.

### BRIEF DESCRIPTION OF THE FIGURES

The drawings illustrate generally, by way of example, but not by way of limitation, various embodiments discussed in the present document.

FIG. 1 illustrates a method of making an object including at least one carbide, in accordance with various embodiments.

FIG. 2 illustrates a method of making an object including at least one carbide, in accordance with various embodiments.

### DETAILED DESCRIPTION OF THE INVENTION

Reference will now be made in detail to certain embodiments of the disclosed subject matter, examples of which are illustrated in part in the accompanying drawings. While the disclosed subject matter will be described in conjunction with the enumerated claims, it will be understood that the exemplified subject matter is not intended to limit the claims to the disclosed subject matter.

Values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “about 0.1% to about 5%” or “about 0.1% to 5%” should be interpreted to include not just about 0.1% to about 5%, but also the individual values (e.g., 1%, 2%, 3%, and 4%) and the sub-ranges (e.g., 0.1% to 0.5%, 1.1% to 2.2%, 3.3% to 4.4%) within the indicated range. The statement “about X to Y” has the same meaning as “about X to about Y,” unless indicated otherwise. Likewise, the statement “about X, Y, or about Z” has the same meaning as “about X, about Y, or about Z,” unless indicated otherwise.

In this document, the terms “a,” “an,” or “the” are used to include one or more than one unless the context clearly dictates otherwise. The term “or” is used to refer to a nonexclusive “or” unless otherwise indicated. The statement “at least one of A and B” has the same meaning as “A, B, or A and B.” In addition, it is to be understood that the phraseology or terminology employed herein, and not otherwise defined, is for the purpose of description only and not of limitation. Any use of section headings is intended to aid reading of the document and is not to be interpreted as limiting; information that is relevant to a section heading may occur within or outside of that particular section.

In the methods of manufacturing described herein, the acts can be carried out in any order without departing from the principles of the invention, except when a temporal or operational sequence is explicitly recited. Furthermore, specified acts can be carried out concurrently unless explicit claim language recites that they be carried out separately. For example, a claimed act of doing X and a claimed act of doing Y can be conducted simultaneously within a single operation, and the resulting process will fall within the literal scope of the claimed process.

The term “about” as used herein can allow for a degree of variability in a value or range, for example, within 10%, within 5%, or within 1% of a stated value or of a stated limit of a range.

The term “substantially” as used herein refers to a majority of, or mostly, as in at least about 50%, 60%, 70%, 80%, 90%, 95%, 96%, 97%, 98%, 99%, 99.5%, 99.9%, 99.99%, or at least about 99.999% or more.

The term “room temperature” as used herein refers to a temperature of about 15° C. to 28° C.

The term “standard temperature and pressure” as used herein refers to 20° C. and 101 kPa.

In various embodiments, the present invention provides a method of manufacturing an object. The method includes depositing a powder including at least one carbide. The method includes exposing at least part of the powder to a laser light. The exposure to the laser light is sufficient to heat the exposed powder such that the powder is at least partially liquefied or at least partially plasticized. The exposed powder cools to form a solidified powder. The method includes repeating the depositing and the exposing for multiple cycles to form an object including the solidified powder from the multiple cycles.

In various embodiments, the present invention provides a method of manufacturing an object. The method includes depositing a powder that is about 95 wt % to about 100 wt % tungsten carbide. The method includes exposing at least part of the powder to a laser light to heat the exposed powder sufficiently to at least partially liquefy or at least partially plasticize the powder such that after the exposing the exposed powder cools to form a solidified powder. The exposing is performed under an atmosphere that is substantially unreactive with the tungsten carbide. The method includes repeating the depositing and the exposing for multiple cycles to form an object including the solidified powder from the multiple cycles.

In various embodiments, the present invention provides a method of manufacturing an object. The method includes exposing at least part of a powder that is about 50 wt % to about 100 wt % one or more carbides to a laser light to heat the exposed powder sufficiently to at least partially liquefy or at least partially plasticize the powder. The method includes depositing the exposed powder. The exposed powder cools to form a solidified powder. The method includes repeating the exposing and the depositing for multiple cycles to form an object including the solidified powder from the multiple cycles.

In various embodiments, the present invention provides an apparatus for manufacturing an object. The apparatus includes a depositing device configured to deposit a powder including at least one carbide. The apparatus includes a laser configured to expose at least part of the powder to a laser light to heat the exposed powder sufficiently to at least partially liquefy or at least partially plasticize the powder such that after the exposing the exposed powder cools to form a solidified powder. The apparatus is configured to repeat the depositing and the exposing for multiple cycles such that an object including the solidified powder from the multiple cycles is formed.

In various embodiments, the method can include compressing the heated powder, such as via a mechanical device, to help the powder to deform and bond to the surface below it before the exposed powder cools to form a solidified powder. In some embodiments, the powder can be substantially free of binders, while in other embodiments, the powder can include one or more binders. The method can include forming a temperature buffer layer (e.g., about 0.1 mm to about 10 mm thick) to help prevent overheating of a work surface or work area, wherein the initial layers of powder are not heated to as high a temperature with the laser as later layers. Later in the process, the temperature buffer layer of carbide powder that was not heated to as high a temperature as used during subsequent cycles and having a correspondingly different physical properties can be removed. In various embodiments, the deposited powder can include a secondary powder that can be removed later, binders, volatile materials, or any suitable material in addition to the one or more carbides.

Various embodiments of the present invention have certain advantages over other methods, apparatuses, and systems for generating objects including carbides, such as tungsten carbide, at least some of which are unexpected. For example, various embodiments can generate objects including carbides, such as tungsten carbide, more quickly. Various embodiments can generate substantially binder-free carbide objects which can have superior properties to binder-containing carbide objects, such as at least one of increased acid resistance (e.g., due at least partially to being free of acid-sensitive binders), increased strength, and increased durability. As compared to other methods of making carbide objects, such as tungsten carbide objects, various embodiments can generate higher quality objects that can have less internal stress, and that have at least one of higher density, better tensile strength, and more resistance to erosion or wear. Various embodiments can be used to create objects that are not possible when using conventional methods. Various embodiments can also generate parts from a conception phase directly to finished products.

Method of manufacturing an object.

Various embodiments provide a method of manufacturing an object. The method is a method of additive manufacturing or 3D printing an object including at least one carbide, such as tungsten carbide or boron carbide. The object includes a large amount of the one or more carbides, such as about 50 wt % to about 100 wt %, about 75% to about 100 wt %, or about 50 wt % or more, or about 55 wt %. 60, 65, 70, 75, 80, 85, 90, 95, 96, 97, 98, or about 99 wt % or more carbides. The object can be any suitable object. The object made by the method can be a solid object, such that each portion of the object is continuously connected to each other portion of the object. The object can be free of moving parts. In some embodiments, moving parts or discontinuous parts can be added to the object after the method of manufacturing the object is performed.

In various embodiments, the depositing of the powder can include depositing the powder including one or more carbides on a work area. The work area can be any suitable work area, such as a flat work area, such as a plate, a stand, or solidified powder from a prior depositing/exposing cycle. In some embodiments, in a repeated cycle, the work area wherein the powder is deposited is such that the deposited powder at least partially contacts the solidified powder formed during a prior cycle, such as the immediately prior cycle or another prior cycle. The work area can be movable, such as from side to side during deposition of the powder or during exposure of the powder to the laser light. The work area can be movable up and down such that after a solidified layer of powder is formed the work area can be lowered. The work area can include a heat sink or can be otherwise configured to provide cooling or heat dissipation, such as with air cooling or with a refrigerated surface.

The powder can be deposited in any suitable form. The powder can be deposited as a powder. The powder can be deposited as a slurry (e.g., wherein the deposited medium includes the powder and a liquid such as an organic solvent, water, an oil, or a combination thereof). The powder can be deposited with an additive; for example, the powder including one or more carbides can include one or more other powders mixed therewith, or can be combined with a resin. In various embodiments, the powder including one or more carbides can be deposited such that the deposited medium including the powder includes about 20 wt % to about 100 wt % of the powder, about 90 wt % to about 100 wt % of the powder, or about 20 wt % or less of the powder, or about 25 wt %, 30, 35, 40, 45, 50, 55, 60, 65, 70, 75, 80, 85, 90, 91, 92, 93, 94, 95, 96, 97, 98, 99, 99.5, 99.9, 99.99, or about 99.999 wt % of the powder or more. In some embodiments, the powder including one or more carbides is deposited in substantially pure form, such that the deposited medium substantially or only includes the powder including one or more carbides. In various embodiments, additives, such as liquids for creating a slurry, or other additives such as resins or binders, can be designed to evaporate or pyrrolize during the heating and liquification of the powder, such that the finished object includes less of the liquid or additive, or such that the liquid or additive is substantially eliminated from the finished object.

In some embodiments, the powder is dropped or sprayed onto the surface. The powder can be deposited via extrusion. In some embodiments, the powder is printed (e.g., onto the work area), such as via inkjet printing or via any suitable method. In some embodiments, after a layer of powder is deposited, a binding liquid or resin can be sprayed thereon in a selected pattern (e.g., via inkjet printing), and the powder that is not sprayed or bound can be removed such as via blowing with air or agitation.

The powder can be deposited in an even layer on any suitable amount of the work area. In some embodiments, the powder can be deposited on the entire work area, or on about 1 surface area % to about 99 surface area % of the work area, or on less than about 1 surface area %, or on 2, 3, 4, 5, 6, 7, 8, 9, 10, 15, 20, 25, 30, 35, 40, 45, 50, 55, 60, 65, 70, 75, 80, 85, 90, 91, 92, 93, 94, 95, 96, 97, 98, or on about 99 surface area % or more of the work area. In some embodiments, the powder can be deposited in a shape or pattern on the work area that resembles the shape or pattern of a 2D-slice of the object that is being generated by the method. The deposited powder can have any suitable thickness. The deposited powder can have a thickness of about 0.1 μm to about 1000 μm, about 10 μm to about 300 μm, about 50 μm to about 150 μm, or about 0.1 μm or less, or about 0.5 μm, 1, 2, 3, 4, 5, 10, 15, 20, 25, 50, 75, 100, 125, 150, 175, 200, 250, 300, 400, 500, 600, 700, 800, 900, or about 1000 μm or more. In some embodiments, the deposited powder can be compressed, such as prior to exposing the deposited powder to the laser light, after exposing the deposited powder to the laser light, or a combination thereof. The compressing can occur in any suitable manner, such as via a roller or a press, and can include providing any suitable amount of force to the deposited powder. A roller or press used to compress the powder can be made of any suitable material, such as one or more carbides, and can be optionally chilled or cooled to help reduce sticking. The compressing can reduce the amount of open space that occurs between particles of the powder, which can reduce the amount of surface-height variation that can occur after the liquification and solidification of the powder, and can provide a more consistent density of the solidified powder. The compressing can cause powder particles to embed in previous layers of the part. The compressed deposited powder can have any suitable thickness, such as about 0.1 μm to about 1000 μm, about 10 μm to about 300 μm, about 50 μm to about 150 μm, or about 0.1 μm or less, or about 0.5 μm, 1, 2, 3, 4, 5, 10, 15, 20, 25, 50, 75, 100, 125, 150, 175, 200, 250, 300, 400, 500, 600, 700, 800, 900, or about 1000 μm or more.

The powder including one or more carbides can include any one or more carbides. In some examples, the one or more carbides include at least one interstitial carbide, such as at least one of titanium carbide, zirconium carbide, hafnium carbide, vanadium carbide, niobium carbide, tantalum carbide, chromium carbide, molybdenum carbide, boron carbide, and tungsten carbide. The one or more carbides can include tungsten carbide;

The powder including one or more carbides can include tungsten carbide. In various embodiments, a powder including tungsten carbide can include or more additional carbides, while in other embodiments the powder including tungsten carbide only includes the single carbide tungsten carbide and is substantially free of all other carbides. The powder including tungsten carbide can have any proportion of tungsten carbide therein. For example, the powder including the tungsten carbide can be about 50 wt % to about 100 wt % tungsten carbide, about 95 wt % to about 100 wt % tungsten carbide, or about 50 wt % or less tungsten carbide, or about 55 wt %, 60, 65, 70, 75, 80, 85, 90, 91, 92, 93, 94, 95, 96, 97, 98, 99, 99.5, 99.9, 99.99, or about 99.999 wt % tungsten carbide.

The remainder (e.g., non-carbide parts) of the powder can be any suitable component, such as an inorganic material, a mineral, a sand, a clay, silica, cobalt, an organic material, a polymer, a thermoplastic, a wax, diamond, garnet, corundum, sapphire, ruby, and a metal (e.g., nickel, titanium) or an alloy thereof, such as about 0.001 wt % to about 50 wt %, about 0.01 wt % to about 25 wt %, about 0.1 wt % to about 10 wt %, or about 0.001 wt % or less, or about 0.01 wt %, 0.1, 1, 2, 3, 4, 5, 6, 8, 10, 12, 14, 16, 18, 20, 25, 30, 35, 40, 45, or about 50 wt % of the powder or more. In some embodiments, the powder including one or more carbides is substantially free of additive materials. In some embodiments, the powder including one or more carbides is substantially free of binders.

The powder can include one or more structural materials other than carbides. In some examples, the powder can include a structural material such as iron, an iron alloy (e.g., steel), aluminum, an aluminum alloy, molybdenum, a molybdenum alloy, tantalum, or a tantalum alloy. Any suitable portion of the powder can be one or more non-carbide structural materials, such as about 0.001 wt % to about 50 wt %, about 0.01 wt % to about 25 wt %, about 0.1 wt % to about 10 wt %, or about 0.001 wt % or less, or about 0.01 wt %, 0.1, 1, 2, 3, 4, 5, 6, 8, 10, 12, 14, 16, 18, 20, 25, 30, 35, 40, 45, or about 50 wt % or more.

In various embodiments, the powder including one or more carbides can be substantially free of binders. In some embodiments, the powder can include one or more binders. Binders are materials having a melting point below the one or more carbides, e.g., substantially below the one or more carbides. For example, a binder can have a melting point of about 50° C. to about 2500° C., about 100° C. to about 2000° C., or about 150° C. to about 1000° C., or about 50° C. or less, or about 75° C., 100, 125, 150, 175, 200, 250, 300, 400, 500, 600, 700, 800, 900, 1,000, 1,100, 1,200, 1,300, 1,400, 1,500, 1,600, 1,700, 1,800, 1,900, 2,000, 2,100, 2,200, 2,300, 2,400° C., or about 2,500° C. or higher. Examples of binders can include any suitable material, such as cobalt, nickel, titanium, beryllium, and alloys of any member thereof. Embodiments of the powder including binders can include any suitable proportion of binders, such as about 0.001 wt % to about 50 wt %, about 0.01 wt % to about 25 wt %, about 0.1 wt % to about 10 wt %, or about 0.001 wt % or less, or about 0.01 wt %, 0.1, 1, 2, 3, 4, 5, 6, 8, 10, 12, 14, 16, 18, 20, 25, 30, 35, 40, 45, or about 50 wt % or more.

In various embodiments, the powder including one or more carbides can include one or more volatile materials, such as a material that reacts with air or causes another desired chemical reaction in the finished product. The volatile material can be flammable, reactive with air, reactive with water (e.g., water in air or liquid water), or explosive. The volatile material can allow the created object to be degradable under various conditions (e.g., in water, in air, over time, at specific temperatures). The volatile material can allow the created object to undergo a change in properties under various conditions (e.g., a decrease in strength or density). In various embodiments, the volatile material can be magnesium, sodium, potassium, lithium, or calcium. Embodiments of the powder including volatile materials can include any suitable proportion of the volatile materials, such as about 0.001 wt % to about 50 wt %, about 0.01 wt % to about 25 wt %, about 0.1 wt % to about 10 wt %, or about 0.001 wt % or less, or about 0.01 wt %, 0.1, 1, 2, 3, 4, 5, 6, 8, 10, 12, 14, 16, 18, 20, 25, 30, 35, 40, 45, or about 50 wt % or more.

The powder including the one or more carbides can have any suitable particle size, wherein for nonspherical particles the particle size is the largest dimension, such as an average particle size (e.g., weight or number average) of about 0.001 μm to about 50 μm, about 0.001 μm to about 0.1 μm, about 0.01 μm to about 10 μm, or about 0.001 μm or less, or about 0.005 μm, 0.01, 0.05, 0.1, 0.5, 1, 2, 3, 4, 5, 6, 7, 8, 9, 10, 15, 20, 25, 30, 35, 40, 45, or about 50 μm or more. The powder can have any suitable particle distribution, for example, about 10 wt % to about 100 wt %, or about 10 wt % or less, or about 20 wt %, 30, 40, 50, 60, 70, 80, 90, or about 95 wt % or more of the particles can have a particle size that is within about 0.001 μm to about 50 μm of one another, or about 0.001 μm to about 0.1 μm, about 0.01 μm to about 10 μm, or about 0.001 μm or less, or about 0.005 μm, 0.01, 0.05, 0.1, 0.5, 1, 2, 3, 4, 5, 6, 7, 8, 9, 10, 15, 20, 25, 30, 35, 40, 45, or within about 50 μm or more of one another.

The method includes exposing at least part of the powder including one or more carbides to a laser light. The laser light can be any suitable laser light, having any suitable intensity, duration, and beam size. In various embodiments, the laser light can be generated by a laser that is at least one of a gas laser, a chemical laser, a dye laser, a metal-vapor laser, a solid-state laser, a semiconductor laser, or another laser such as a free electron laser, a gas dynamic laser, a Raman laser, and a nuclear pumped laser. The gas laser can be at least one of a helium-neon laser, argon laser, krypton laser, xenon ion laser, nitrogen laser, carbon dioxide laser, carbon monoxide laser, and an excimer laser. The chemical laser can be at least one of a hydrogen fluoride laser, deuterium fluoride laser, chemical oxygen-iodine laser (COIL), and an all gas-phase iodine laser (AGIL). The metal-vapor laser can be a laser using metal vapors such as at least one of helium-cadmium metal vapor, helium-mercury, helium-selenium, helium-silver, strontium vapor, neon-copper, copper, and gold metal vapor. The solid-state laser can be at least one of a ruby laser, a neodymium-doped yttrium aluminium garnet (Nd:Y₃Al₅O₁₂) laser, a neodymium- and -chromium-doped yttrium aluminum garnet (NdCrY₃Al₅O₁₂) laser, an erbium-doped yttrium aluminum garnet (Er:Y₃Al₅O₁₂) laser, a neodymium-doped yttrium lithium fluoride (Nd:LiYF₄) laser, a neodymium-doped yttrium orthovanadate (Nd:YVO₄) laser, a neodymium-doped yttrium calcium oxoborate (Nd:YCa₄O(BO₃)₃) laser, a neodymium glass (Nd:glass) laser, a titanium sapphire (Ti:sapphire) laser, a thulium yttrium aluminum garnet (Tm: Y₃Al₅ O₁₂) laser, a ytterbium yttrium aluminum garnet (Yb: Y₃Al₅O₁₂) laser, a ytterbium-doped glass laser, a holmium-doped yttrium aluminum garnet (Ho:Y₃Al₅O₁₂) laser, a chromium-doped zinc selenide (Cr:ZnSe) laser, a cerium-doped lithium strontium (or calcium) aluminum fluoride (Ce:LiSAF, Ce:LiCAF) laser, a chromium doped chrysoberyl (alexandrite) laser, and an erbium-doped or erbium-ytterbium-codoped glass laser. The semiconductor laser can be at least one of a semiconductor laser diode, GaN laser, InGaN laser, AlGaInP or AlGaAs laser, InGaAsP laser, lead salt laser, quantum cascade laser, and a hybrid silicon laser.

The exposing can occur at least one of before and after the powder has been deposited (e.g., onto the work area). In some embodiments, the exposing is performed prior to the depositing of the powder, such that the partially liquefied or plasticized powder is deposited. In embodiments wherein the powder is exposed prior to deposition onto the work area, the force of the at least partially liquefied or plasticized powder contacting the work area can be sufficient to form a compressed layer of the deposited powder. In some embodiments, the exposing is performed after the depositing of the powder.

The exposing is sufficient to sinter and at least partially liquefy (e.g., melt at least a portion of) or at least partially plasticize (e.g., soften at least a portion of) the powder. After the exposing, the exposed powder is allowed to cool, allowing the at least partially liquefied powder to solidify, forming a solidified powder. In various embodiments, all of the powder that solidifies is melted or softened by the exposing. In some embodiments, only part of the powder that solidifies is melted or softened by the exposing. For example, the exposing the at least part of the powder sufficiently to form the solidified powder includes exposing the at least part of the powder with a duration and intensity of the laser light such that about 40 wt % to about 100 wt % of the at least part of the powder becomes a liquid or becomes softened, or about 80 wt % to about 100 wt %, or about 40 wt % or less, or about 45 wt %, 50, 55, 60, 65, 70, 75, 80, 85, 90, 91, 92, 93, 94, 95, 96, 97, 98, 99, 99.5, or about 99.9 wt % or more. The at least partially liquefied or plasticized powder can be a free-flowing liquid that stays in place due to, for example, at least one of a short heating and cooling time, due to the small size of the heated material, due to attraction to itself (e.g., surface tension), and due to attraction to the work area on which it sits. The at least partially liquefied or plasticized powder can be a gel-like liquid or a softened solid that includes solid or soft-solid portions along with liquefied portions. In some embodiments, a softened powder can have so much solid character that liquefied portions of the solid can only be observed using microscopy techniques or other characterization methods that allow detection of small amounts of liquids within a solid; such a softened solid can also be referred to as a partially liquefied powder or a plasticized powder herein. In some embodiments, a softened powder can have no liquefied portions, but can have any suitable portion that is softened; such a softened solid can be referred to as an at least partially plasticized powder herein.

The exposing of the at least part of the deposited powder that is sufficient to at least partially liquefy or plasticize the exposed powder can be of a suitable duration and intensity such that the exposed powder attains any suitable temperature such that it is at least partially liquefied or plasticized. In some embodiments, the duration and intensity of the exposing can be sufficient to raise the temperature of the exposed powder to about 100° C. to about 5,000° C., 1,000° C. to about 4000° C., 1,500° C. to about 3,500° C., 1,750° C. to about 3,250° C., 2,600° C. to about 3,000° C., or about 2,785° C. to about 2,830° C., or about 100° C. or less, or about 200, 300, 400, 500, 600, 700, 800, 900, 1,000, 1,100, 1,200, 1,300, 1,400, 1,500, 1,600, 1,700, 1,800, 1,900, 2,000, 2,100, 2,200, 2,300, 2,400, 2,450, 2,500, 2,550, 2,600, 2,625, 2,650, 2,675, 2,700, 2,725, 2,750, 2,775, 2,800, 2,825, 2,850, 2,875, 2,900, 2,925, 2,950, 2,975, 3,000, 3,050, 3,100, 3,150, 3,200, 3,250, 3,300, 3,400, 3,500, 3,600, 3,700, 3,800, 3,900, 4,000, 4,250, 4,500, 4,750, or about 5,000° C. or more.

The depositing and the exposing are repeated for multiple cycles to form an object including the solidified powder from the multiple cycles. Any suitable number of cycles of the depositing and exposing can be performed, such as at least 2, or 4, 6, 8, 10, 15, 20, 25, 50, 75, 100, 125, 150, 200, 250, 500, 750, 1,000, 1,500, 2,000, 2,500, or about 5,000 or more. The formed object need not be a completed object. For example, additional processing steps can be performed on the formed object after the repeated cycles before the object is finished, such as at least one of cooling, grinding, sanding, polishing, buffing, removal of material (e.g., solidified, unsolidified, or partially solidified material), and addition of additional parts via any suitable method.

In various embodiments, less than all of the powder deposited during a single cycle can be exposed to the laser light during the exposing. For example, about 1 wt % to about 99 wt % of the deposited powder can be exposed to the laser light during the exposing during a single cycle, or about 30 wt % to about 80 wt % of the deposited powder, or about 1 wt % or less, or about 2 wt %, 3, 4, 5, 6, 8, 10, 12, 14, 16, 18, 20, 25, 30, 35, 40, 45, 50, 55, 60, 65, 70, 75, 80, 85, 90, 91, 92, 93, 94, 95, 96, 97, 98, or about 99 wt % or more of the deposited powder can be exposed to the laser light during the exposing during a single cycle. The powder including the one or more carbides that is not exposed to the laser light during a particular cycle can be exposed to laser light in another cycle or can be removed at the end of the cycle, at the end of another cycle, or after the method is completed. In some embodiments, the unsolidified powder can help to support other layers in subsequent cycles (e.g., for overhanging portions of the object), and can thus be left in place to serve a useful purpose during subsequent cycles before removal during or after a later cycle or after the method is complete. In various embodiments, the removed unsolidified powder can be reused in the method, such as for manufacturing the same object or for manufacturing a different object. Any suitable method of removing the unsolidified powder can be used, such as agitation, pressurized air (e.g., air blasting), brushing, sanding (e.g., micro-sanding), bead blasting (e.g., micro bead-blasting), flowing or pressurized fluid (e.g., oil or water jet).

In some embodiments, all of the powder including the one or more carbides that is exposed to the laser light is exposed to the same intensity and duration of the laser light, such that each portion of the exposed powder liquefies or plasticizes to about the same extent and solidifies to form a solid having approximately uniform properties. In some embodiments, the duration, intensity, type of laser light, or other aspects, vary in a suitable manner across the exposed powder, such that the properties of the exposed powder and a solidified solid resulting therefrom vary. For example, in some embodiments, a portion of the deposited powder including the one or more carbides can be exposed to a higher duration or intensity of the laser light such that they at least partially liquefy or plasticize and cool to form a solid, while another portion of the deposited powder including the one or more carbides can be exposed to a lower duration or intensity of the laser light such that they do not liquefy or plasticize at all (and remain powder) or liquefy or plasticize to a lesser extent to form a solid with different properties. In various embodiments, the different properties of the solid formed from the lesser-liquified or lesser-plasticized portions can become a useful part of the object being manufactured, or can be removed from the object during or after the method. In some embodiments, powdered or partially solidified material can help to support subsequent deposited layers, such as for overhanging portions of the object, and can thus be left in place to serve a useful purpose until during or after a later cycle or after completion of the method. In various embodiments, the removed solidified or unsolidified powder can be reused in the method, such as for manufacturing the same object or for manufacturing a different object. Any suitable method of removing a powder or the solid formed from the less-exposed portions can be used, such as agitation, pressurized air (e.g., air blasting), brushing, sanding (e.g., micro-sanding), bead blasting (e.g., micro bead-blasting), flowing or pressurized fluid (e.g., oil or water jet).

The solidified portion of the exposed powder including one or more carbides that was sufficiently exposed to be at least partially liquefied or plasticized can have any suitable ultimate tensile strength, such as about 100 MPa to about 345 MPa, about 250 MPa to about 345 MPa, about 340 MPa to about 350 MPa, about 100 MPa or less, about 125 MPa, 150, 175, 200, 225, 250, 275, 300, 310, 315, 320, 325, 330, 335, 340, 345, or about 350 MPa or more. In embodiments wherein a portion of the powder including one or more carbides is exposed to a lesser intensity, duration, or type of the laser light, the ultimate tensile strength of a solid formed therefrom can be any suitable value, such as a lower ultimate tensile strength than the other exposed portions of the powder, such as about 100 MPa to about 345 MPa, about 250 MPa to about 345 MPa, about 340 MPa to about 350 MPa, about 100 MPa or less, about 125 MPa, 150, 175, 200, 225, 250, 275, 300, 310, 315, 320, 325, 330, 335, 340, 345, or about 350 MPa or more.

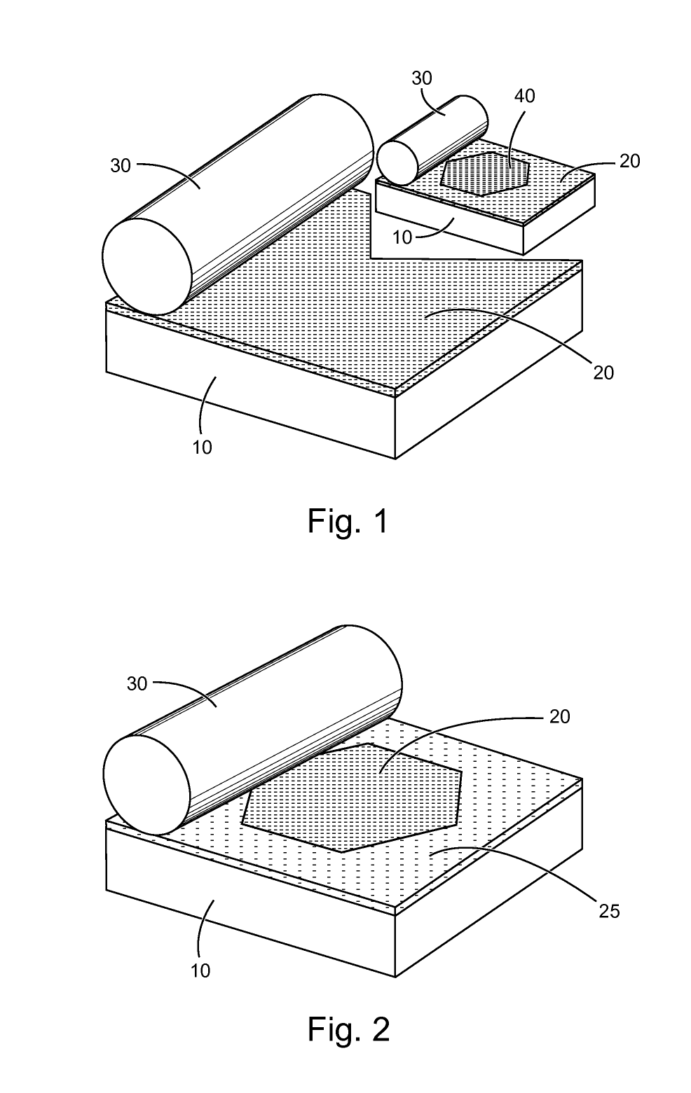

FIG. 1 illustrates a method of making an object including one or more carbides, in accordance with various embodiments. The method can include depositing a powder comprising one or more carbides (e.g., at least one of tungsten carbide and boron carbide) on a work area, which can be work plate 10 for the first cycle and solidified layers from prior cycles for a later cycle. The deposited one or more carbides can form a layer 20. The method can include compressing the layer 20 using a roller or press 30. The method can include exposing at least part of the powder (inset, exposed powder 40) to a laser light to heat the exposed powder 40 sufficiently to at least partially liquefy or plasticize the powder such that after the exposing the exposed powder 40 cools to form a solidified powder. The compressing can occur before the exposing, after the exposing, or a combination thereof. The depositing and the exposing can be repeated for multiple cycles to form an object comprising the solidified powder from the multiple cycles.

In some embodiments, the powder including one or more carbides is a primary powder, wherein the depositing further includes depositing a secondary powder, wherein the exposing does not solidify the secondary powder or only partially solidifies the secondary powder. In some embodiments, the secondary powder can be exposed to the laser light, while in other embodiments, the secondary powder can be not exposed to the laser light. The exposing of the secondary powder can be of the same duration, intensity, and laser type as the exposing of the primary powder, or can be of a different duration, intensity, and laser type. The secondary powder can be left in place in one or more cycles to provide stabilization for subsequent layers (e.g., corresponding to overhanging portions of the object). In some embodiments, the secondary powder or a solid formed therefrom can be left in place in or on the object. The method can include removing the non-solidified secondary powder or partially solidified secondary powder at least one of during and after formation of the object. The secondary powder can include a filler. The secondary powder can include an inorganic material, a mineral, a sand, a clay, silica, an organic material, a polymer, a thermoplastic, a wax, and a metal or alloy (e.g., having a lower melting point than the one or more carbides). In some embodiments, the secondary powder includes silica. The secondary powder can have any suitable average particle size (e.g., weight or number average) of about 0.001 μm to about 50 μm, about 0.001 μm to about 0.1 μm, about 0.01 μm to about 10 μm, or about 0.001 μm or less, or about 0.005 μm, 0.01, 0.05, 0.1, 0.5, 1, 2, 3, 4, 5, 6, 7, 8, 9, 10, 15, 20, 25, 30, 35, 40, 45, or about 50 μm or more. The secondary powder can have any suitable size distribution, for example, about 10 wt % to about 100 wt %, or about 10 wt % or less, or about 20 wt %, 30, 40, 50, 60, 70, 80, 90, or about 95 wt % or more of the particles can have a particle size that is within about 0.001 μm to about 50 μm of one another, or about 0.001 μm to about 0.1 μm, about 0.01 μm to about 10 μm, or about 0.001 μm or less, or about 0.005 μm, 0.01, 0.05, 0.1, 0.5, 1, 2, 3, 4, 5, 6, 7, 8, 9, 10, 15, 20, 25, 30, 35, 40, 45, or within about 50 μm or more of one another. Any suitable method of removing the secondary powder or solid formed therefrom can be used, such as agitation, pressurized air (e.g., air blasting), brushing, sanding (e.g., micro-sanding), bead blasting (e.g., micro bead-blasting), flowing or pressurized fluid (e.g., oil or water jet), or melting.

In various embodiments, some of the layers of deposited powder, such as the first few layers, can be heated to incrementally higher temperatures, to avoid heating a work plate or other work surface to an intolerably high temperature (e.g., to avoid damaging the work area). For example, over two or more of the repeated cycles, the exposing the at least part of the powder to the laser light sufficiently to form the solidified powder includes exposing the at least part of the deposited powder to the laser light using an intensity and duration such that the exposed liquefied or plasticized powder in a repeated cycle achieves a higher maximum temperature than the exposed liquefied powder or plasticized in a prior cycle. During initial cycles, a maximum temperature of the powder during the exposing to the laser light can be increased over two or more cycles, such as a maximum temperature during the first cycle of about 500° C. to about 1000° C., with maximum temperatures increasing in subsequent cycles by about 100° C. to about 1500° C. until the desired temperature is reached over 2, 3, 4, 5, 6, 7, 8, 9, 10, 11, 12, 13, 14, 15, 16, 17, 18, 19, or about 20 cycles, after which the desired temperature is reached in each cycle. The initial solidified layers (e.g., temperature buffer layer on the forming object) created by the lower temperature cycles can have any suitable thickness, such as about 0.1 mm to about 50 mm, or about 0.5 mm to about 10 mm, or about 0.1 mm or less, or about 0.2, 0.4, 0.5, 0.6, 0.8, 1, 1.5, 2, 2.5, 3, 4, 5, 6, 7, 8, 9, 10, 15, 20, 25, 30, 35, 40, 45, or about 50 mm or more. In various embodiments, after a cycle such as the final cycle, the initial solidified layers formed using lower temperatures can be removed via any suitable method, such that only solidified layers formed using high temperatures remain.

The heating of the powder including one or more carbides can be performed under an atmosphere that avoids chemical reaction of the one or more carbides with materials in the atmosphere, such as to avoid oxidation and degradation of the one or more carbides. Any suitable atmosphere unreactive with the one or more carbides can be used. For example, an inert atmosphere of a noble gas such as argon can be used. An atmosphere of hydrogen can be used, such as including about 30 vol % or more hydrogen, or about 40 vol %, 45, 50, 55, 60, 65, 70, 75, 80, 85, 90, 91, 92, 93, 94, 95, 96, 97, 98, or about 99 vol % or more hydrogen can be used.

### Object.

In various embodiments, the present invention provides an object made by the method described herein. An object made by the method herein can have advantages over carbide objects (e.g., tungsten carbide) made from other methods. For example, embodiments of the object including the one or more carbides can have less internal stress than carbide objects made by other methods, resulting in better properties such as higher ultimate tensile strength, such as such as about 50 MPa to about 450 MPa, about 100 MPa to about 345 MPa, about 250 MPa to about 345 MPa, about 340 MPa to about 350 MPa, about 100 MPa or less, about 125 MPa, 150, 175, 200, 225, 250, 275, 300, 310, 315, 320, 325, 330, 335, 340, 345, or about 350 MPa or more. An object made by the method can have a Young's modulus of about 200 GPa to about 1,000 GPa, about 400 GPa to about 800 GPa, or about 400 GPa or less, or about 425 GPa, 450, 475, 500, 525, 550, 575, 600, 625, 650, 675, 700, 725, 750, 775, or about 800 GPa or more. An object made by the method can have any suitable bulk modulus, such as about 100 GPa to about 800 GPa, about 200 GPa to about 600 GPa, or about 200 GPa or less, or about 225 GPa, 250, 275, 300, 325, 350, 375, 400, 425, 450, 475, 500, 525, 550, 575, or about 600 GPa or more. An object made by the method can have any suitable shear modulus, such as about 50 GPa, to about 800 GPa, about 100 GPa to about 500 GPa, or about 100 GPa or less, or about 125 GPa, 150, 175, 200, 225, 250, 275, 300, 325, 350, 375, 400, 425, 450, 475, or about 500 GPa or more. An object made by the method can have any suitable hardness, such as on the Moh's scale about 6 to about 12, about 7 to about 11, or about 7 or less, or about 7.2, 7.4, 7.6, 7.8, 8, 8.2, 8.4, 8.5, 8.6, 8.7, 8.8, 8.9, 9.0, 9.1, 9.2, 9.3, 9.4, 9.5, 9.6, 9.8, 10, 10.2, 10.4, 10.6, 10.8, or about 11 or more. An object made by the method can have any suitable Vickers number, such as about 1,500 to about 2,800, about 1,700 to about 2,400, or about 1,500 or less, or about 1,600, 1,700, 1,750, 1,800, 1,850, 1,900, 1,950, 2,000, 2,050, 2,100, 2,150, 2,200, 2,250, 2,300, 2,350, 2,400, 2,500, 2,600, 2,700, or about 2,800 or more.

The object can be any suitable object. In some examples, the object can be a nozzle, such as a jetting nozzle. The object can be an object (e.g., a tool or part) used for treatment of a subterranean formation such as related to petroleum recovery, such as a drill bit, reamer, or a part of a drill bit or reamer, a drill string part, a tubular, a valve or valve part, a pump part, a compressor part, a motor part, an adapter, a joint, a sensor part (e.g., for sensing flow rate or temperature), a shoe, a collar, a actuator part, a sleeve, a plug, a filter or screen, a coupling, or a heat exchanger part. The object can be any object used during one or more subterranean treatments such as a drilling, stimulation fluid, fracturing, spotting, clean-up, completion, remedial treatment, abandonment, acidizing, cementing, logging, or a combination thereof.

### Apparatus or System.

In various embodiments, the present invention provides an apparatus or system. The apparatus or system can be any suitable apparatus or system that can be used to perform any embodiment of the method described herein. For example, the system or apparatus can include a depositing device configured to deposit a powder including one or more carbides (e.g., on a work area). The system or apparatus can include a laser configured to expose at least part of the powder to a laser light to heat the exposed powder sufficiently to at least partially liquefy or plasticize the powder such that after the exposing the exposed powder cools to form a solidified powder. The system or apparatus can be configured to repeat the depositing and the exposing for multiple cycles such that an object including the solidified powder from the multiple cycles is formed.

The terms and expressions that have been employed are used as terms of description and not of limitation, and there is no intention in the use of such terms and expressions of excluding any equivalents of the features shown and described or portions thereof, but it is recognized that various modifications are possible within the scope of the embodiments of the present invention. Thus, it should be understood that although the present invention has been specifically disclosed by specific embodiments and optional features, modification and variation of the concepts herein disclosed may be resorted to by those of ordinary skill in the art, and that such modifications and variations are considered to be within the scope of embodiments of the present invention.

### Additional Embodiments.

The following exemplary embodiments are provided, the numbering of which is not to be construed as designating levels of importance:

Embodiment 1 provides a method of manufacturing an object, the method comprising:
depositing a powder comprising one or more carbides;
exposing at least part of the powder to a laser light to heat the exposed powder sufficiently to at least partially liquefy or at least partially plasticize the powder such that after the exposing the exposed powder cools to form a solidified powder; and
repeating the depositing and the exposing for multiple cycles to form an object comprising the solidified powder from the multiple cycles.

Embodiment 2 provides the method of Embodiment 1, wherein the carbide is an interstitial carbide.

Embodiment 3 provides the method of any one of Embodiments 1-2, wherein the carbide is at least one of titanium carbide, zirconium carbide, hafnium carbide, vanadium carbide, niobium carbide, tantalum carbide, chromium carbide, molybdenum carbide, boron carbide, and tungsten carbide.

Embodiment 4 provides the method of any one of Embodiments 1-3, wherein the carbide is tungsten carbide.

Embodiment 5 provides the method of any one of Embodiments 1-4, wherein the deposited powder has a thickness of about 0.1 μm to about 1000 μm.

Embodiment 6 provides the method of any one of Embodiments 1-5, wherein the deposited powder has a thickness of about 10 μm to about 300 μm.

Embodiment 7 provides the method of any one of Embodiments 1-6, further comprising compressing the deposited powder prior to the exposing or after the exposing.

Embodiment 8 provides the method of Embodiment 7, wherein the compressing comprises applying a roller or press to the deposited powder.

Embodiment 9 provides the method of any one of Embodiments 7-8, wherein the compressed deposited powder has a thickness of about 0.1 μm to about 1000 μm.

Embodiment 10 provides the method of any one of Embodiments 7-9, wherein the compressed deposited powder has a thickness of about 10 μm to about 300 μm.

Embodiment 11 provides the method of any one of Embodiments 1-10, wherein the powder is deposited at least one of as a powder, as a slurry, with an additive, and as a combination with one or more other powders.

Embodiment 12 provides the method of any one of Embodiments 1-11, wherein during the multiple cycles, the depositing comprises depositing the powder sufficiently to at least partially contact the solidified powder formed during a prior cycle.

Embodiment 13 provides the method of any one of Embodiments 1-12, wherein the exposing is performed prior to the depositing of the powder, such that the at least partially liquefied or plasticized powder is deposited.

Embodiment 14 provides the method of any one of Embodiments 1-13, wherein the exposing is performed after the depositing of the powder.

Embodiment 15 provides the method of any one of Embodiments 1-14, wherein less than all of the deposited powder is exposed to the laser light during the exposing.

Embodiment 16 provides the method of Embodiment 15, wherein the deposited powder that is not exposed to the laser light during the exposing is not solidified during the exposing.

Embodiment 17 provides the method of any one of Embodiments 1-16, wherein the exposing solidifies part of the deposited powder more than another part of the deposited powder.

Embodiment 18 provides the method of Embodiment 17, wherein the deposited powder that is not fully solidified comprises non-solidified powder or partially solidified powder.

Embodiment 19 provides the method of any one of Embodiments 17-18, wherein the exposing comprises exposing some portions of the deposited powder with greater intensity or duration of the laser light than other portions, such that the portions exposed to the greater intensity or duration become the solidified powder, while the portions not exposed to the greater intensity or duration become non-solidified powder or partially solidified powder.

Embodiment 20 provides the method of any one of Embodiments 17-19, further comprising removing the non-solidified powder or partially solidified powder at least one of during and after formation of the object.

Embodiment 21 provides the method of Embodiment 20, further comprising reusing at least some of the removed non-solidified powder or partially solidified powder in a subsequent depositing.

Embodiment 22 provides the method of any one of Embodiments 1-21, wherein the powder comprising the carbide is a primary powder, wherein the depositing further comprises depositing a secondary powder, wherein the exposing does not solidify the secondary powder or only partially solidifies the secondary powder.

Embodiment 23 provides the method of Embodiment 22, further comprising removing the non-solidified secondary powder or partially solidified secondary powder at least one of during and after formation of the object.

Embodiment 24 provides the method of any one of Embodiments 22-23, wherein the secondary powder comprises a filler.

Embodiment 25 provides the method of any one of Embodiments 22-24, wherein the secondary powder comprises an inorganic material, a mineral, a sand, a clay, silica, an organic material, a polymer, a thermoplastic, a wax, and a metal or alloy.

Embodiment 26 provides the method of any one of Embodiments 22-25, wherein the secondary powder comprises silica.

Embodiment 27 provides the method of any one of Embodiments 22-26, wherein the secondary powder has an average particle size of about 0.001 μm to about 50 μm.

Embodiment 28 provides the method of any one of Embodiments 1-27, wherein exposing the at least part of the powder sufficiently to form the solidified powder comprises exposing the at least part of the powder with a duration and intensity of the laser light such that about 40 wt % to about 100 wt % of the at least part of the powder becomes a liquid and allowing the liquefied or plasticized powder to solidify.

Embodiment 29 provides the method of any one of Embodiments 1-28, wherein exposing the at least part of the powder sufficiently to form the solidified powder comprises exposing the at least part of the powder with a duration and intensity of the laser light such that about 80 wt % to about 100 wt % of the at least part of the powder becomes a liquid and allowing the liquefied or plasticized powder to solidify.

Embodiment 30 provides the method of any one of Embodiments 1-29, wherein exposing the at least part of the powder to the laser light sufficiently to form the solidified powder comprises exposing the at least part of the deposited powder to the laser light using a duration and intensity such that the exposed powder has a temperature of about 100° C. to about 5,000° C.

Embodiment 31 provides the method of any one of Embodiments 1-30, wherein exposing the at least part of the powder to the laser light sufficiently to form the solidified powder comprises exposing the at least part of the deposited powder to the laser light using a duration and intensity such that the exposed powder has a temperature of about 2,785° C. to about 2,830° C.

Embodiment 32 provides the method of any one of Embodiments 1-31, wherein over two or more of the repeated cycles, the exposing the at least part of the powder to the laser light sufficiently to form the solidified powder comprises exposing the at least part of the deposited powder to the laser light using an intensity and duration such that the exposed liquefied or plasticized powder in a repeated cycle achieves a higher maximum temperature than the exposed liquefied or plasticized powder in a prior cycle.

Embodiment 33 provides the method of any one of Embodiments 1-32, wherein during initial cycles, a maximum temperature of the powder during the exposing to the laser light is increased over two or more cycles.

Embodiment 34 provides the method of any one of Embodiments 1-33, wherein depositing comprises depositing the powder on a work area.

Embodiment 35 provides the method of any one of Embodiments 1-34, further comprising performing the exposing with the exposed deposited powder under an atmosphere that is substantially unreactive with the tungsten carbide.

Embodiment 36 provides the method of Embodiment 35, wherein the atmosphere comprises argon.

Embodiment 37 provides the method of any one of Embodiments 35-36, wherein the atmosphere comprises hydrogen.

Embodiment 38 provides the method of any one of Embodiments 1-37, wherein a laser that generates the laser light is at least one of a gas laser, a chemical laser, a dye laser, a metal-vapor laser, a solid-state laser, and a semiconductor laser.

Embodiment 39 provides the method of any one of Embodiments 1-38, wherein the powder comprising the carbide is about 50 wt % to about 100 wt % of the one or more carbides.

Embodiment 40 provides the method of any one of Embodiments 1-39, wherein the powder comprising the carbide is about 95 wt % to about 100 wt % tungsten carbide.

Embodiment 41 provides the method of any one of Embodiments 1-40, wherein the powder comprising the carbide is about 50 wt % to about 100 wt % tungsten carbide.

Embodiment 42 provides the method of any one of Embodiments 1-41, wherein the powder comprising the carbide is about 95 wt % to about 100 wt % tungsten carbide.

Embodiment 43 provides the method of any one of Embodiments 1-42, wherein the powder comprising the carbide is substantially free of binders.

Embodiment 44 provides the method of any one of Embodiments 1-43, wherein the powder comprising the carbide has an average particle size of about 0.001 μm to about 50 μm.

Embodiment 45 provides the method of any one of Embodiments 1-44, wherein the powder comprising the carbide has an average particle size of about 0.01 μm to about 10 μm.

Embodiment 46 provides the object manufactured by the method of any one of Embodiments 1-45.

Embodiment 47 provides an apparatus or system configured to perform the method of any one of Embodiments 1-46.

Embodiment 48 provides a method of manufacturing an object, the method comprising:
depositing a powder that is about 95 wt % to about 100 wt % tungsten carbide;
exposing at least part of the powder to a laser light to heat the exposed powder sufficiently to at least partially liquefy or at least partially plasticize the powder such that after the exposing the exposed powder cools to form a solidified powder, wherein the exposing is performed under an atmosphere that is substantially unreactive with the tungsten carbide; and
repeating the depositing and the exposing for multiple cycles to form an object comprising the solidified powder from the multiple cycles is formed.

Embodiment 49 provides a method of manufacturing an object, the method comprising:
exposing at least part of a powder that is about 95 wt % to about 100 wt % one or more carbides to a laser light to heat the exposed powder sufficiently to at least partially liquefy or at least partially plasticize the powder;
depositing the exposed powder, wherein the exposed powder cools to form a solidified powder; and
repeating the exposing and the depositing for multiple cycles to form an object comprising the solidified powder from the multiple cycles.

Embodiment 50 provides an apparatus for manufacturing an object, the apparatus comprising:
a depositing device configured to deposit a powder comprising at least one carbide; and
a laser configured to expose at least part of the powder to a laser light to heat the exposed powder sufficiently to at least partially liquefy or at least partially plasticize the powder such that after the exposing the exposed powder cools to form a solidified powder;
wherein the apparatus is configured to repeat the depositing and the exposing for multiple cycles such that an object comprising the solidified powder from the multiple cycles is formed.

Embodiment 51 provides the composition, apparatus, or method of any one or any combination of Embodiments 1-50 optionally configured such that all elements or options recited are available to use or select from.

What is claimed is:

1. A method of manufacturing an object, the method comprising:
depositing a powder comprising one or more carbides;
exposing at least part of the powder to a laser light to heat the exposed powder sufficiently to at least partially liquefy or at least partially plasticize the powder such that after the exposing the exposed powder cools to form a solidified powder; and
repeating the depositing and the exposing for multiple cycles to form an object comprising the solidified powder from the multiple cycles.

2. The method of claim 1, wherein the carbide is an interstitial carbide.

3. The method of claim 1, wherein the carbide is at least one of titanium carbide, zirconium carbide, hafnium carbide, vanadium carbide, niobium carbide, tantalum carbide, chromium carbide, molybdenum carbide, boron carbide, and tungsten carbide.

4. The method of claim 1, wherein the carbide is tungsten carbide.

5. The method of claim 1, wherein the deposited powder has a thickness of about 0.1 μm to about 1000 μm.

6. The method of claim 1, wherein the deposited powder has a thickness of about 10 μm to about 300 μm.

7. The method of claim 1, further comprising compressing the deposited powder prior to the exposing or after the exposing.

8. The method of claim 7, wherein the compressing comprises applying a roller or press to the deposited powder.

9. The method of claim 7, wherein the compressed deposited powder has a thickness of about 0.1 μm to about 1000 μm.

10. The method of claim 7, wherein the compressed deposited powder has a thickness of about 10 μm to about 300 μm.

11. The method of claim 1, wherein the powder is deposited at least one of as a powder, as a slurry, with an additive, and as a combination with one or more other powders.

12. The method of claim 1, wherein during the multiple cycles, the depositing comprises depositing the powder sufficiently to at least partially contact the solidified powder formed during a prior cycle.

13. The method of claim 1, wherein the exposing is performed prior to the depositing of the powder, such that the at least partially liquefied or plasticized powder is deposited.

14. The method of claim 1, wherein the exposing is performed after the depositing of the powder.

15. The method of claim 1, wherein less than all of the deposited powder is exposed to the laser light during the exposing.

16. The method of claim 15, wherein the deposited powder that is not exposed to the laser light during the exposing is not solidified during the exposing.

17. The method of claim 1, wherein the exposing solidifies part of the deposited powder more than another part of the deposited powder.

18. The method of claim 17, wherein the deposited powder that is not fully solidified comprises non-solidified powder or partially solidified powder.

19. The method of claim 17, wherein the exposing comprises exposing some portions of the deposited powder with greater intensity or duration of the laser light than other portions, such that the portions exposed to the greater intensity or duration become the solidified powder, while the portions not exposed to the greater intensity or duration become non-solidified powder or partially solidified powder.

20. The method of claim 17, further comprising removing the non-solidified powder or partially solidified powder at least one of during and after formation of the object.

21. The method of claim 20, further comprising reusing at least some of the removed non-solidified powder or partially solidified powder in a subsequent depositing.

22. The method of claim 1, wherein the powder comprising the carbide is a primary powder, wherein the depositing further comprises depositing a secondary powder, wherein the exposing does not solidify the secondary powder or only partially solidifies the secondary powder.

23. The method of claim 22, further comprising removing the non-solidified secondary powder or partially solidified secondary powder at least one of during and after formation of the object.

24. The method of claim 22, wherein the secondary powder comprises a filler.

25. The method of claim 22, wherein the secondary powder comprises an inorganic material, a mineral, a sand, a clay, silica, an organic material, a polymer, a thermoplastic, a wax, and a metal or alloy.

26. The method of claim 22, wherein the secondary powder comprises silica.

27. The method of claim 22, wherein the secondary powder has an average particle size of about 0.001 μm to about 50 μm.

28. The method of claim 1, wherein exposing the at least part of the powder sufficiently to form the solidified powder comprises exposing the at least part of the powder with a duration and intensity of the laser light such that about 40 wt % to about 100 wt % of the at least part of the powder becomes a liquid and allowing the liquefied or plasticized powder to solidify.

29. The method of claim 1, wherein exposing the at least part of the powder sufficiently to form the solidified powder comprises exposing the at least part of the powder with a duration and intensity of the laser light such that about 80 wt % to about 100 wt % of the at least part of the powder becomes a liquid and allowing the liquefied or plasticized powder to solidify.

30. The method of claim 1, wherein exposing the at least part of the powder to the laser light sufficiently to form the solidified powder comprises exposing the at least part of the deposited powder to the laser light using a duration and intensity such that the exposed powder has a temperature of about 100° C. to about 5,000° C.

31. The method of claim 1, wherein exposing the at least part of the powder to the laser light sufficiently to form the solidified powder comprises exposing the at least part of the deposited powder to the laser light using a duration and intensity such that the exposed powder has a temperature of about 2,785° C. to about 2,830° C.

32. The method of claim 1, wherein over two or more of the repeated cycles, the exposing the at least part of the powder to the laser light sufficiently to form the solidified powder comprises exposing the at least part of the deposited powder to the laser light using an intensity and duration such that the exposed liquefied or plasticized powder in a repeated cycle achieves a higher maximum temperature than the exposed liquefied or plasticized powder in a prior cycle.

33. The method of claim 1, wherein during initial cycles, a maximum temperature of the powder during the exposing to the laser light is increased over two or more cycles.

34. The method of claim 1, wherein depositing comprises depositing the powder on a work area.

35. The method of claim 1, further comprising performing the exposing with the exposed deposited powder under an atmosphere that is substantially unreactive with the tungsten carbide.

36. The method of claim 35, wherein the atmosphere comprises argon.

37. The method of claim 35, wherein the atmosphere comprises hydrogen.

38. The method of claim 1, wherein a laser that generates the laser light is at least one of a gas laser, a chemical laser, a dye laser, a metal-vapor laser, a solid-state laser, and a semiconductor laser.

39. The method of claim 1, wherein the powder comprising the carbide is about 50 wt % to about 100 wt % of the one or more carbides.

40. The method of claim 1, wherein the powder comprising the carbide is about 95 wt % to about 100 wt % tungsten carbide.

41. The method of claim 1, wherein the powder comprising the carbide is about 50 wt % to about 100 wt % tungsten carbide.

42. The method of claim 1, wherein the powder comprising the carbide is about 95 wt % to about 100 wt % tungsten carbide.

43. The method of claim 1, wherein the powder comprising the carbide is substantially free of binders.

44. The method of claim 1, wherein the powder comprising the carbide has an average particle size of about 0.001 μm to about 50 μm.

45. The method of claim 1, wherein the powder comprising the carbide has an average particle size of about 0.01 μm to about 10 μm.

46. The object manufactured by the method of claim 1.

47. An apparatus or system configured to perform the method of claim 1.

48. A method of manufacturing an object, the method comprising:
depositing a powder that is about 95 wt % to about 100 wt % tungsten carbide;
exposing at least part of the powder to a laser light to heat the exposed powder sufficiently to at least partially liquefy or at least partially plasticize the powder such that after the exposing the exposed powder cools to form a solidified powder, wherein the exposing is performed under an atmosphere that is substantially unreactive with the tungsten carbide; and
repeating the depositing and the exposing for multiple cycles to form an object comprising the solidified powder from the multiple cycles is formed.

49. A method of manufacturing an object, the method comprising:
exposing at least part of a powder that is about 95 wt % to about 100 wt % one or more carbides to a laser light to heat the exposed powder sufficiently to at least partially liquefy or at least partially plasticize the powder;
depositing the exposed powder, wherein the exposed powder cools to form a solidified powder; and
repeating the exposing and the depositing for multiple cycles to form an object comprising the solidified powder from the multiple cycles.

50. An apparatus for manufacturing an object, the apparatus comprising:
a depositing device configured to deposit a powder comprising at least one carbide; and
a laser configured to expose at least part of the powder to a laser light to heat the exposed powder sufficiently to at least partially liquefy or at least partially plasticize the powder such that after the exposing the exposed powder cools to form a solidified powder;
wherein the apparatus is configured to repeat the depositing and the exposing for multiple cycles such that an object comprising the solidified powder from the multiple cycles is formed.
